(19) United States
(12) Patent Application Publication
(10) Pub. No.: US 2021/0291085 A1
(43) Pub. Date: Sep. 23, 2021

(54) METHOD FOR MAINTAINING A FILTRATION DEVICE OF A SYSTEM FOR EXTRACTING A LIQUID FROM A TANK OF A MOTOR VEHICLE

(71) Applicant: VITESCO TECHNOLOGIES GmbH, Hannover (DE)

(72) Inventors: Charles-Albert FISCHBACH, Toulouse (FR); Cheikh DIOUF, Toulouse (FR)

(21) Appl. No.: 17/204,113

(22) Filed: Mar. 17, 2021

(30) Foreign Application Priority Data
Mar. 18, 2020 (FR) 2002625

(51) Int. Cl. B01D 29/66; F01N 3/20; B01D 29/60; B01D 35/143; B01D 35/027; B01D 53/94

(52) U.S. Cl. CPC B01D 29/66; F01N 3/2066; B01D 29/606; B01D 35/143; B01D 2201/54; B01D 35/027; B01D 53/9431; F01N 2610/1426; F01N 2610/02; B01D 29/603

(57) ABSTRACT

A method is disclosed for maintaining a filtration device of a system for extracting a liquid from a tank of a motor vehicle. The method is based on risk criteria for detecting (301) the choking of the device and on application criteria for identifying (302) a context favorable to the cleaning of the filtration device. The cleaning of the filtration device, based on generating (303) a reverse stream in the extraction system, is thus only triggered when specific, configurable conditions are identified.

### CROSS-REFERENCE TO RELATED APPLICATIONS

This application claims priority to FR 2002625 filed Mar. 18, 2020, the entire contents of which is hereby incorporated by reference.

### BACKGROUND OF THE INVENTION

### Field of the Invention

The present invention generally relates to exhaust gas treatment systems of motor vehicles. It relates more particularly to maintaining a device for filtering the liquid additive used in such systems for controlling the pollution of the exhaust gases from the engine of the motor vehicle. The invention is in particular applicable in vehicles provided with diesel engines, for example light vehicles, utility vehicles or trucks (or heavy goods vehicles) including such an engine.

### Description of the Related Art

The exhaust gases generated by vehicles with compression-ignition engines (known as diesel engines) or by vehicles with spark-ignition engines (known as gasoline engines) are made up particularly of gaseous atmospheric pollutants such as carbon oxides (COx, used to refer to CO and CO2) and nitrogen oxides (NOx, used to refer to NO and NO2). Diesel engines in particular are subject to regulations aimed at reducing the quantity of pollutant gases that they emit. The standards capping the nitrogen oxide levels emitted are an example of this, and tend to be increasingly restrictive.

For vehicles provided with a diesel engine, in which it is already the case, and for vehicles provided with a gasoline engine, in which it could soon become the case, the pollution of the exhaust gases from the engine can be controlled by means of a gas treatment system that implements a pollution control method such as the SCR (Selective Catalytic Reduction) method. The SCR method uses a pollution control liquid additive in order to selectively reduce the nitrogen oxides (NOx) contained in the exhaust gases. Pollution control liquid additive is given to mean a pollution control product that can be injected into an exhaust gas treatment device of an engine with the aim of controlling the pollution of the exhaust gases before they are discharged into the atmosphere.

The liquid additive commonly used in the SCR method is called Diesel Exhaust Fluid, or DEF. This additive, also marketed under the AdBlue® brand, is a 32.5% (by mass) aqueous urea solution, which is an ammonia precursor (NH3). In this context, the heat energy supplied by the exhaust is a catalyst for the conversion of the DEF into ammonia. The ammonia reacts with the nitrogen oxides (NOx) in the exhaust gases to give less polluting species, namely nitrogen (N2), water and carbon dioxide (CO2). The ammonia used in the SCR method is thus a reducing agent, supplied in the form of a liquid additive.

In vehicles provided with an exhaust gas treatment system, the liquid additive is generally stored in a dedicated tank. It is extracted from it by an extraction system that particularly comprises a pump suitable for circulating it in a hydraulic circuit, at a given flow rate, to an injector. The role of this injector is to spray the correct quantity of additive, at each instant, into the exhaust gas stream in the form of microdroplets, under the control of a control unit. The role of the control unit is to meter the quantity of additive to be injected depending on the actual needs of the exhaust gas treatment system, and to control the injector accordingly. This metering and control are performed depending on parameters such as, for example, the temperature of the liquid additive or the hydraulic pressure at a given instant.

In addition to the pump, an extraction system generally comprises at least one device for filtering the liquid additive. The main filtration device is situated upstream of the pump in the hydraulic circuit. It reduces the risk that the liquid reaching the pump and, later, the injector, is contaminated by impurities (for example dust or suspended particles). Such contamination could result in the deterioration of the performance of the extraction system and, more widely, the exhaust gas treatment system as a whole. Typically, for all-terrain vehicles that are provided with an exhaust gas treatment system and used off-road, the liquid additive contained in the dedicated tank is frequently contaminated by such impurities. The incorporation of a filtration device into the system makes it possible to maintain the performance level of the exhaust gas treatment system for an optimum period despite the possible contamination of the liquid by impurities.

However, it is known that the performance of the filtration devices themselves can deteriorate during use. In particular, as a contaminated liquid stream passes through a filtration device over time, impurities can build up in said filtration device. The performance of the exhaust gas treatment system deteriorates as a result of this gradual choking, or even clogging, of the filtration device.

Furthermore, two types of filtration device are commonly used in extraction systems. Firstly, filtration devices known as relative filters, the filtration efficiency of which depends on the size of the filtered particles. For example, X% for particles of size Y. Secondly, filtration devices known as absolute filters that act as a mesh that only lets through particles that are smaller than the mesh. In other words, particles larger than a given value are trapped by the filtration device. In the case of absolute filters in particular, the particles that are trapped in the filter gradually reduce the liquid flow rate through the device. The liquid flow rate required by the injector can then no longer be obtained during nominal operation of the pump. As a result, beyond a certain choking of the filtration device, the performance of the exhaust gas treatment system can deteriorate again, this time due to the filtration device.

When a filtration device has exceeded a certain choking level, and in particular when it is an absolute filter, it must thus be dismantled so that it can be cleaned or replaced and to allow the exhaust gas treatment system to retain a sufficient level of performance in light of the standards imposed. The dismantling operations necessary to remove the filtration device from the extraction system can be painstaking and lengthy. They also usually require that the vehicle be immobilized for a significant period. In such an extraction system, the capacity of the filtration device to retain behavior close to its nominal behavior is thus critical. Furthermore, depending on the type of vehicle on which such an extraction system is installed and the use made of this vehicle, the speed at which the filtration device is capable of choking varies greatly.

### SUMMARY OF THE INVENTION

The invention aims to attenuate the aforementioned drawbacks of the prior art by proposing a method that makes it possible to increase the period for which a filtration device of a system for extracting liquid from a tank of a motor vehicle offers performance close to its nominal performance. The filtration device can thus be used for a longer period without requiring inconvenient operations to keep it in working condition or replace it. Furthermore, the method can be configured in advance to suit the type of vehicle on which the system is installed and its actual operating conditions. The filtration device is only cleaned on the basis of criteria specifically adapted to the actual operating conditions of the vehicle and the method thus makes it possible to optimize the resources consumed to perform it.

To this end, a first aspect of the invention proposes a method for maintaining a filtration device of a system for extracting a liquid from a tank of a motor vehicle, said extraction system comprising a reversible pump and a filtration device, said reversible pump including a first port connected to the tank by means of the filtration device and a suction pipe, and a second port connected to an injection device by means of a discharge pipe, said extraction system further comprising a return pipe connected to the discharge pipe by its first end and connected to the tank by its second end, said method comprising the following steps, performed by a control unit of the extraction system:
a) detecting the choking of the filtration device on the basis of at least one risk criterion linked to the operation of the extraction system;
b) identifying a context favorable to the cleaning of the filtration device on the basis of at least one application criterion linked to the state of the liquid in the tank; and
c) closing the injection device and generating, by means of the reversible pump, for a given time, a reverse stream of liquid going from the tank starting from the return pipe to the tank via the suction pipe, through the filtration device, in the direction from the return pipe towards the suction pipe.

Embodiments taken individually or in combination further provide that:

During step a), each risk criterion linked to the operation of the extraction system corresponds to the meeting of at least one given condition of the following conditions:
the pressure measured in the pressure pipe by a pressure sensor during an injection phase drops within a time below a given threshold value, by a value greater than a given threshold value;
the volume of liquid extracted from the tank by the extraction system since the installation of the filtration device is greater than a given threshold value;
the number of tank filling operations performed since the installation of the filtration device is greater than a given threshold value;
the total pressure increase time during the pressurizing of the liquid by the pump is greater than a given threshold value;
the operating speed of the pump during the pressurizing of the liquid by said pump is greater than a given threshold value;
the pressure drop during a given injection of liquid by the injection device is greater than a given threshold value; and
the environmental conditions of the extraction system are nominal.

During step a), a given weight is associated respectively with each risk criterion, and the choking of the filtration device is detected on the basis of the risk criteria weighted by the weights associated respectively with each risk criterion.

During step b), each application criterion linked to the state of the liquid in the tank corresponds to the meeting of at least one given condition of the following conditions:
the tank contains a quantity of liquid greater than a given threshold value;
the vehicle is stationary;
a value associated with a given quality criterion of the liquid is greater than a given threshold value; and
the time elapsed between two given driving cycles of the vehicle is greater than a given threshold value.

During step b), a given weight is associated respectively with each application criterion, and a context favorable to the cleaning of the filtration device is detected on the basis of the application criteria weighted by the weights associated respectively with each application criterion.

During step c), the generation of the reverse stream of liquid going from the tank to the tank, in the direction from the return pipe towards the suction pipe, is stopped when at least one of the following conditions is met:
the reverse stream is generated for a time greater than a given threshold value;
the pressure measured in the pressure pipe by a pressure sensor drops by a value greater than a given threshold value in a given time interval; and
the pressure measured in the pressure pipe by a pressure sensor is greater than a given threshold value for a given time.

The method further comprises, following the performance of step c), a second performance of step a) and, if the choking of the filtration device is detected, the storing in a memory of an item of information associated with the deterioration of the filtration device and/or the issuing of a warning, by means of a human-machine interface of the vehicle, indicating the deterioration of the filtration device.

The number of iterations and/or the frequency of the iterations of the method are stored in a memory and, on the basis of said number of iterations and said iteration frequency, an item of information associated with the need to replace the filtration device is stored in a memory and/or a warning is issued, by means of a human-machine interface of the vehicle, indicating the need to replace the filtration device.

In a second aspect, the invention also relates to a control unit of a system for extracting a liquid from a tank of a motor vehicle, comprising means for implementing all of the steps of the method for maintaining a device for filtering the liquid according to the first aspect.

In a third aspect, the invention also relates to a system for extracting a liquid from a tank of a motor vehicle comprising a reversible pump and a filtration device, said reversible pump including a first port connected to the tank by means of the filtration device and a suction pipe, and a second port connected to an injection device by means of a discharge pipe, said extraction system further comprising a return pipe connected to the discharge pipe by its first end and connected to the tank by its second end, and a control unit according to the second aspect.

Embodiments taken individually or in combination further provide that:

The extraction system is suitable for extracting liquid additive from a dedicated tank of a motor vehicle and injecting said liquid additive into an exhaust gas treatment system of said motor vehicle.

The extraction system further comprises a second filtration device situated between the first and second ends of the return pipe.

The second end of the return pipe is situated in the tank at a given height suitable for avoiding the intake of particles settled at the bottom of the tank or particles suspended on the surface of the liquid contained in the tank.

### BRIEF DESCRIPTION OF THE DRAWINGS

Other features and advantages of the invention will become more apparent upon reading the following description. This description is purely illustrative and should be read with reference to the appended drawings, in which:

FIG. 1 is a block diagram of a motor vehicle engine with an exhaust gas treatment device for reducing the NOx;

FIG. 2 is a schematic representation of a system for extracting a liquid from a motor vehicle tank according to one embodiment of the invention;

FIG. 3 is a diagram of steps of an embodiment of the method according to the invention;

FIG. 4 is a diagram of steps of an embodiment of step a) of the method in FIG. 3;

FIG. 5 is a diagram of steps of an embodiment of step b) of the method in FIG. 3; and

FIG. 6 is a diagram of steps of an embodiment of step c) of the method in FIG. 3.

### DESCRIPTION OF THE PREFERRED EMBODIMENTS

In the following description of the embodiments and in the figures of the attached drawings, the same or similar elements have the same numerical reference signs in the drawings.

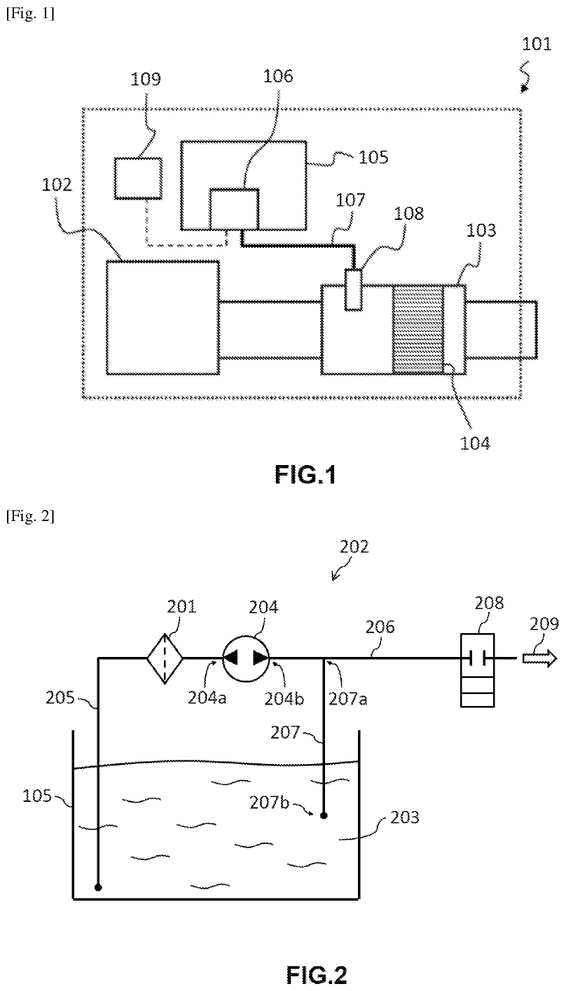

FIG. 1 is a schematic representation of a motor vehicle 101 with an internal combustion engine 102, for example a diesel engine. The motor vehicle 101 is for example a private car, a utility vehicle, a truck or a coach. The motor vehicle 101 also comprises an exhaust gas treatment system 103 with a catalytic converter (or catalyst) 104 for implementing the SCR pollution control method. The vehicle 101 comprises a tank 105 for the liquid additive. The tank 105 is connected to an injector 108 for spraying the liquid additive into the gas treatment system 103, by means of a pipe 107. The injector is supplied with pressurized liquid additive by a pump that is for example incorporated into a liquid additive metering module 106 that is located in the tank.

When the engine 102 is operating, it produces exhaust gases, and these gases are directed towards the exhaust gas treatment system 103. The exhaust gas treatment system 103 is supplied with liquid additive by means of a hydraulic circuit formed by the pump incorporated into the module 106, the pipe 107 and the injector 108. The injector 108 sprays the pollution control solution upstream of the catalyst 104 in order to cause the selective catalytic reduction of the NOx according to the SCR method. The pollution control of the exhaust gases is thus achieved.

The liquid additive is extracted and injected into the pollution control system only when necessary and only in the quantity necessary to produce a reaction adapted to the quantity of exhaust gas produced at each instant by the engine 102 and to avoid injecting excess additive, potentially responsible for the production of excess ammonia, and consuming the additive unnecessarily. All of the operations to meter the liquid additive and govern the pump are governed by a control unit 109.

With reference to FIG. 2, a schematic representation of a system for extracting a liquid from a motor vehicle tank according to one embodiment of the invention will now be described. In the example shown, the extraction system 202 is a hydraulic circuit that has the role of conveying liquid additive 203 from the tank 105 in which it is stored to an injector 208 that delivers it, in spray form, to an exhaust gas treatment system or a pollution control system such as the one shown in FIG. 1. A person skilled in the art will appreciate that, in addition to this particular example, such an extraction system can be used to extract, from a tank of a motor vehicle, a liquid for injection into another system by any injection device.

In the non-limiting example shown, the liquid additive, for example DEF sold under the AdBlue® brand, is stored in the tank 105 from which it is extracted by the extraction system 202 at the instants and in the quantity necessary, to be injected into the exhaust gas stream in the pollution control system. More specifically, in the so-called injection configuration, the liquid 203 is drawn by the pump 204 from the tank 105, into the suction pipe 205, then through the filtration device 201 and the pump itself, and then into the pressure pipe 206 to the injector 208. The liquid situated between the pump and the injector is therefore pressurized liquid. The filtration device 201 is a filtration device conventionally used to filter any impurities present in the liquid contained in the tank, as described in the introduction. Furthermore, in a particular embodiment of the extraction system, the filtration device is an absolute filter.

Injection devices such as the injector 208 alternate faster or slower open phases and closed phases that allow the spraying of the liquid represented by the arrow 209. As a result, a return pipe 207 forms a closed loop in the extraction system for reinjecting the pressurized liquid into the tank when the injector is closed. In particular, the end 207a of the return pipe 207 is connected to the pressure pipe 206, while the end 207b is immersed in the tank 105.

Furthermore, in the extraction system 202, the pump 204 is for example a reversible pump capable of drawing the liquid in the hydraulic circuit in one direction or the other. In particular, each of its two ports 204a and 204b can thus alternately be an inlet or an outlet for the liquid stream that the pump generates. Such a reversible pump particularly makes it possible to purge the injector by generating a liquid stream going from the injector to the tank, if applicable. In addition, in a manner known per se to a person skilled in the art, in the configuration in which the injector 208 is closed and a so-called reverse liquid stream is generated (that is, a stream going from the tank to the tank, in the direction from the return pipe towards the suction pipe), it is possible to draw any particles that have built up in the filtration device back into the tank. In other words, the impurities trapped in the filtration device can be pushed by the stream generated by the pump and clear any obstructed orifices. This latter configuration thus finally makes it possible to temporarily clean the filtration device insofar as the particles that return to the tank disperse therein and do not immediately choke the filtration device again when the extraction system is used in the injection configuration.

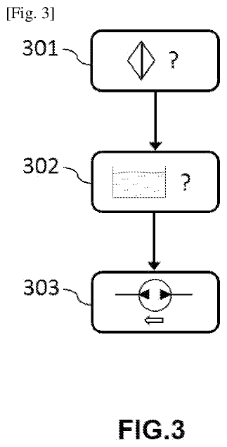

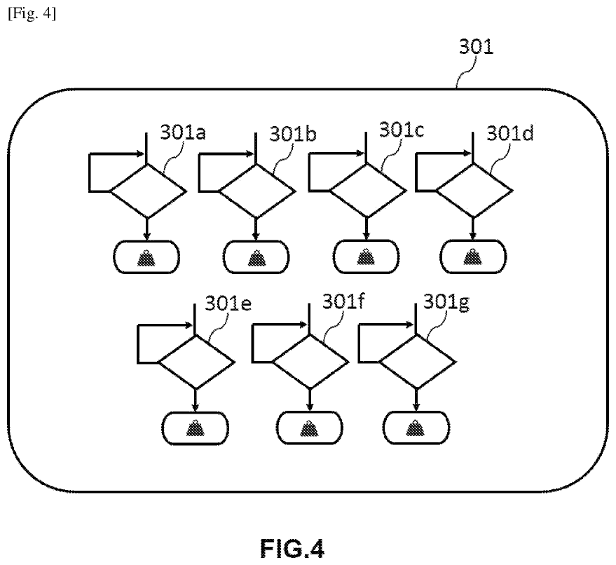

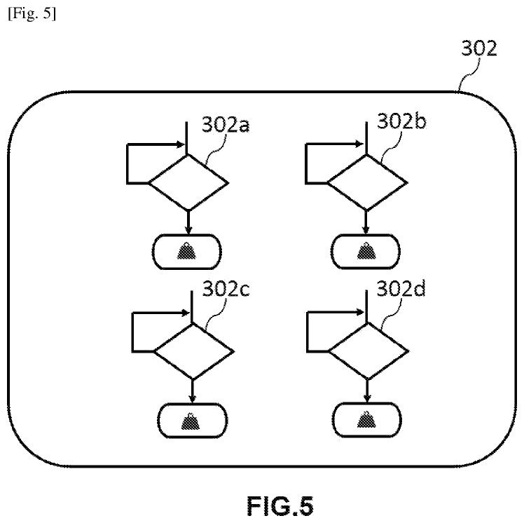

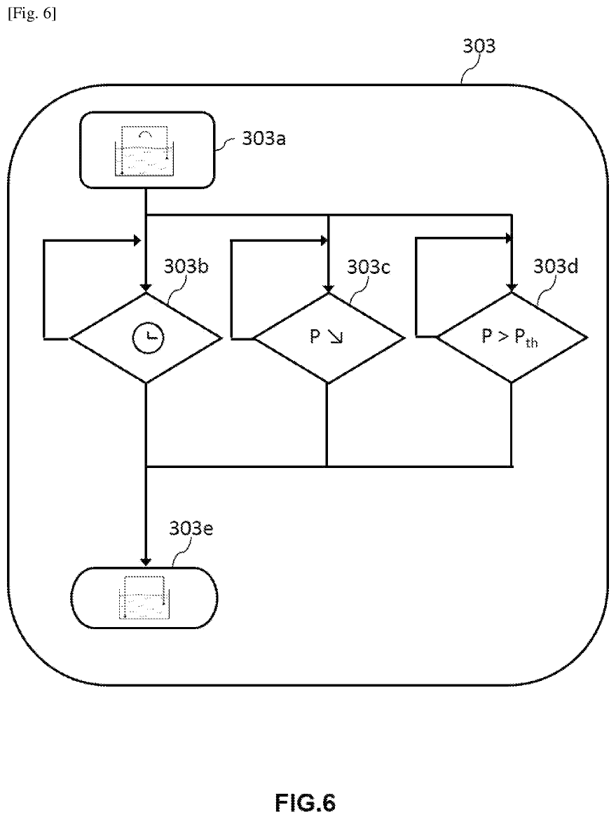

Embodiments of the method according to the invention will now be described with reference to FIG. 3, FIG. 4, FIG. 5 and FIG. 6. The steps of the method are performed by a control unit of the extraction system. In a particular embodiment, this can be for example a control unit of a metering module of a system for treating the pollutant gases of a motor vehicle.

Step 301 of the method as illustrated in FIG. 3 comprises detecting the choking of the filtration device on the basis of at least one risk criterion linked to the operation of the extraction system. “Risk criterion” is used here to denote a predetermined criterion that the control unit performing the method uses to assess the risk of choking of the filtration device. Such a criterion can for example be the operating time of the filtration device, the operating conditions of the extraction system or any other information considered relevant for assessing the risk of choking of the filtration device.

Furthermore, in a particular embodiment of step 301 illustrated by FIG. 4, each risk criterion linked to the operation of the extraction system corresponds for example to the meeting of a given condition. In other words, a risk criterion is taken into account by the control unit when the condition with which it is associated is met. For example, this condition can be one of the following conditions:
condition 301a is met if the pressure measured in the pressure pipe by a pressure sensor during an injection phase drops within a time below a given threshold value, by a value greater than a given threshold value. This effect is the direct result of the choking of the filtration device that partially obstructs said filtration device and reduces the liquid flow rate that passes through it;
condition 301b is met if the volume of liquid extracted from the tank by the extraction system since the installation of the filtration device is greater than a given threshold value. This condition reflects the risk of choking linked to the operating time of the filtration device;
condition 301c is met if the number of fillings of the tank is greater than a given threshold value. This condition reflects the risk of choking linked to the repeated loading of the filtration device;
condition 301d is met if the total pressure increase time during the pressurizing of the liquid by the pump is greater than a given threshold value. This condition reflects the deterioration of the performance of the extraction system resulting from the choking of the filtration device;
condition 301e is met if the operating speed of the pump during the pressurizing of the liquid by said pump is greater than a given threshold value. This condition reflects a change in the behavior of the pump (an increase in its operating speed) resulting from the choking of the filtration device;
condition 301f is met if the pressure drop during an injection of liquid by the injection device is greater than a given threshold value. This condition reflects a change in the behavior of the extraction system that can result from the choking of the filtration device; and
condition 301g is met if the environmental conditions of the extraction system are nominal. This condition reflects possible disruptions of the operation of the extraction system that can be associated with values measured by sensors of said system. For example, a variation in temperature or voltage the magnitude of which can be directly or indirectly linked to the choking of the filtration device.

A person skilled in the art will appreciate that certain of the conditions set out above are based on measurements taken by a pressure sensor suitable for measuring the pressure in the pressure pipe of the extraction system. Such sensors are commonly present in extraction systems and a person skilled in the art will be able to use the results of measurements taken by this sensor to check given conditions.

Furthermore, it will be appreciated that the conditions listed above are non-limiting examples. A person skilled in the art will be able to choose the conditions he or she considers relevant for assessing the risk of choking of the filtration device. The number and type of risk criteria used can thus advantageously be adapted to a specific use case of a filtration device and more broadly of an extraction system in order to take into account the actual operating conditions. In other words, the conditions for triggering the subsequent steps of the method can be configured by a user depending on the expected use of the vehicle in which the extraction system is located.

In addition, in a particular embodiment, a given weight (in the mathematical sense, that is, a weighting factor) is associated respectively with each risk criterion and the choking of the filtration device can be detected on the basis of the risk criteria weighted by the weights associated respectively with each risk criterion. In other words, the effective detection of choking of the filtration device assumes that the cumulative weight of the different risk criteria observed is sufficiently high (for example being greater than a threshold value). This weighting system thus makes it possible to give more or less credit to the different risk criteria used to detect choking. Here again, advantageously, the different weights associated with the different criteria can be configured prior to the use of the method so as to adapt the detection of choking as precisely as possible to a specific use case of the filtration device. For example, depending on whether the vehicle in which the system is installed is intended to be used on the road or not, the different risk criteria can have a different impact on the overall performance of the system.

Step 302 in FIG. 3 comprises identifying a context favorable to the cleaning of the filtration device on the basis of at least one application criterion, linked to the state of the liquid in the tank. Context “favorable to the cleaning” is given to mean a context in which the general situation of the extraction system is favorable to the efficient cleaning of the filtration device. In other words, it is for example a context assumed to allow the efficient cleaning of the filtration device, if applicable. Furthermore, “application criterion” is used here to denote a predetermined criterion on the basis of which the control unit performing the method determines the existence of a context allowing the efficient cleaning of the filtration device. Such a criterion can for example be linked to the mobility of the vehicle at a given instant, the concentration of the liquid in the tank at a given instant, or any other relevant information for determining the existence of a context favorable to cleaning.

Furthermore, in a particular embodiment of step 302 illustrated by FIG. 5, in a similar way to that described above for the risk criteria, each application criterion linked to the state of the liquid in the tank can correspond to the meeting of a given condition. In this case, an application criterion is taken into account by the control unit that is performing the method when the condition with which it is associated is met. For example, this condition can be one of the following conditions:
condition 302a is met if the tank contains a quantity of liquid greater than a given threshold value;

condition 302b is met if the vehicle is stationary. Stationary is given to mean stopped in the sense that the vehicle is immobile;
condition 302c is met if a value associated with a given quality criterion of the liquid is greater than a given threshold value. Such a value can be for example the value of the urea concentration in the liquid additive used for the exhaust gas pollution control; and
condition 302d is met if the time elapsed between two given driving cycles of the vehicle is greater than a given threshold value.

Generally, all of these conditions make it possible to minimize the risk of reintroducing impurities into the extraction system during the cleaning of the filtration device. In particular, depending on whether the liquid is moving or not in the tank, is more or less concentrated, or the impurities are more or less settled in the tank, the cleaning of the filtration device described below poses a greater or lesser risk of reintroducing impurities into the extraction system when the cleaning of the filtration device by a reverse stream is carried out. It is thus advantageously possible to avoid such configurations, which are detrimental to the efficiency of the cleaning, and ensure effective cleaning.

As for the conditions associated with the risk criteria, the conditions listed above are non-limiting examples. A person skilled in the art will be able to choose the conditions he or she considers relevant for helping to identify a situation favorable to the efficient cleaning of the filtration device. Furthermore, the number and type of application criteria used can advantageously be adapted to a specific use case of a filtration device and more broadly of an extraction system in order to take into account the actual operating conditions.

In addition, for step 302 too, in a particular embodiment, a given weight is associated respectively with each application criterion and a context favorable to cleaning is identified on the basis of the risk criteria weighted by the weights associated respectively with each risk criterion. In other words, the effective identification of such a context assumes that the cumulative weight of the different application criteria observed is sufficiently high (for example being greater than a threshold value). This weighting system thus makes it possible to give more or less credit to the different application criteria on the basis of which a context favorable to cleaning is identified. Here again, advantageously, the weights can be configured prior to the use of the method so as to adapt the identification of a context favorable to cleaning as precisely as possible to a specific use case of the filtration device.

Finally, the last step 303 of the method comprises the cleaning of the filtration device by the generation of a reverse stream of liquid in the extraction system, that is, through the generation of a stream of liquid going from the tank to the tank, in the direction from the return pipe towards the suction pipe. In a manner known per se, this reverse stream makes it possible to release any impurities trapped in the filtration device and reintroduce them into the tank. As they disperse in the tank, they then take a certain amount of time to choke the filtration device again, which makes it possible to use it at an optimum performance level.

Furthermore, in a particular embodiment of step 303 illustrated in FIG. 6, the generation of the reverse stream of liquid going from the tank to the tank, in the direction from the return pipe towards the suction pipe, is stopped when one of the following conditions is met:
condition 303a is met if the reverse stream is generated for a time greater than a given threshold value. This condition makes it possible to ensure that the generation time of the reverse stream is sufficient to allow efficient cleaning of the filter;
condition 303c is met the pressure measured in the pressure pipe by a pressure sensor drops by a value greater than a given threshold value in a given time interval. This condition results from the effect produced by the unclogging of orifices of the filtration device obstructed by impurities. The pressure drop makes it possible to be sure that the cleaning is effective. Furthermore, this information can then be used to indicate the effectiveness of the cleaning of the filtration device to a user; and
condition 303d is met if the pressure measured in the pressure pipe by a pressure sensor drops is greater than a given threshold value for a given time. Unlike the preceding condition, this condition is associated with an inability to clean the filtration device. The pressure increases in this case in the pressure pipe but does not drop following the cleaning of the filtration device. This condition makes it possible to interrupt the method, preventing damage to the filtration device by applying high pressure for too long. If applicable, this information can also be used to indicate the ineffectiveness of the cleaning of the filtration device to a user.

In any event, as soon as one of the conditions listed above is met, the generation of the reverse stream in the extraction system is interrupted, as illustrated in box 303e in FIG. 6. Furthermore, the conditions described above are non-limiting examples and a person skilled in the art will be able to select appropriate conditions for leading to the interruption of the cleaning step.

In addition, in a particular embodiment of the method, step 301 is reiterated after step 303 so as to check whether the choking of the filtration device is detected again. Following this, the information associated with the possible choking of the filtration device can be stored in a memory and/or a warning can be issued, by means of a human-machine interface of the vehicle, indicating the choking of the filtration device. As a result, a user can be informed of the fact that it has not been possible to clean the filtration device efficiently during a given iteration of the method.

In another embodiment, the number of iterations and/or the frequency of the iterations of the method are parameters stored in a memory and, on the basis of said number of iterations and said iteration frequency, an item of information associated with the need to replace the filtration device can be stored in a memory for diagnostic purposes, and/or a warning can be issued, by means of a human-machine interface of the vehicle, indicating the need to change the filtration device.

In other embodiments of the method, the extraction system comprises a second filtration device situated between the first and second ends of the return pipe and/or the second end of the return pipe is situated in the tank at a given height suitable for avoiding the intake of particles settled at the bottom of the tank or particles suspended on the surface of the liquid contained in the tank. These variants make it possible to avoid reintroducing impurities into the filtration device during the cleaning step.

In the claims, the term “comprise” or “include” does not exclude other elements or steps. A single processor or several other units can be used to implement the invention. The various features described and/or claimed can advantageously be combined. Their presence in the description or in different dependent claims does not exclude the possibility of combining them. The reference signs should not be understood as limiting the scope of the invention.

1. A method for maintaining a filtration device (201) of a system (202) for extracting a liquid (203) from a tank (105) of a motor vehicle, said extraction system comprising a reversible pump (204) and a filtration device, said reversible pump including a first port (204a) connected to the tank by means of the filtration device and a suction pipe (205), and a second port (204b) connected to an injection device (208) by means of a discharge pipe (206), said extraction system further comprising a return pipe (207) connected to the discharge pipe by a first end (207a) of the return pipe and connected to the tank by a second end (207b) of the return pipe, said method comprising the following steps, performed by a control unit of the extraction system:
a) detecting (301) the choking of the filtration device on the basis of at least one risk criterion linked to the operation of the extraction system;
b) identifying (302) a context favorable to the cleaning of the filtration device on the basis of at least one application criterion linked to the state of the liquid in the tank; and
c) closing the injection device and generating (303), by means of the reversible pump, for a given time, a reverse stream of liquid going from the tank starting from the return pipe to the tank via the suction pipe, through the filtration device, in the direction from the return pipe towards the suction pipe.

2. The method as claimed in claim 1, in which, during step a), each risk criterion linked to the operation of the extraction system corresponds to the meeting of at least one given condition of the following conditions:
the pressure measured in the pressure pipe by a pressure sensor during an injection phase drops within a time below a given threshold value, by a value greater than a given threshold value;
the volume of liquid extracted from the tank by the extraction system since the installation of the filtration device is greater than a given threshold value;
the number of tank filling operations performed since the installation of the filtration device is greater than a given threshold value;
the total pressure increase time during the pressurizing of the liquid by the pump is greater than a given threshold value;
the operating speed of the pump during the pressurizing of the liquid by said pump is greater than a given threshold value;
the pressure drop during a given injection of liquid by the injection device is greater than a given threshold value; and
the environmental conditions of the extraction system are nominal.

3. The method as claimed in claim 2, in which, during step a), a given weight is associated respectively with each risk criterion, and in which the choking of the filtration device is detected on the basis of the risk criteria weighted by the weights associated respectively with each risk criterion.

4. The method as claimed in claim 1, in which, during step b), each application criterion linked to the state of the liquid in the tank corresponds to the meeting of at least one given condition of the following conditions:
the tank contains a quantity of liquid greater than a given threshold value;
the vehicle is stationary;
a value associated with a given quality criterion of the liquid is greater than a given threshold value; and
the time elapsed between two given driving cycles of the vehicle is greater than a given threshold value.

5. The method as claimed in claim 4, in which, during step b), a given weight is associated respectively with each application criterion, and in which a context favorable to the cleaning of the filtration device is detected on the basis of the application criteria weighted by the weights associated respectively with each application criterion.

6. The method as claimed in claim 1, in which, during step c), the generation of the reverse stream of liquid going from the tank to the tank, in the direction from the return pipe towards the suction pipe, is stopped when at least one of the following conditions is met:
the reverse stream is generated for a time greater than a given threshold value;
the pressure measured in the pressure pipe by a pressure sensor drops by a value greater than a given threshold value in a given time interval; and
the pressure measured in the pressure pipe by a pressure sensor drops is greater than a given threshold value for a given time.

7. The method as claimed in claim 1, further comprising, following the performance of step c), a second performance of step a) and, if the choking of the filtration device is detected, the storing in a memory of an item of information associated with the deterioration of the filtration device and/or the issuing of a warning, by means of a human-machine interface of the vehicle, indicating the deterioration of the filtration device.

8. The method as claimed in claim 1, in which the number of iterations and/or the frequency of the iterations of the method are stored in a memory and in which, on the basis of said number of iterations and said iteration frequency, an item of information associated with the need to replace the filtration device is stored in a memory and/or a warning is issued, by means of a human-machine interface of the vehicle, indicating the need to replace the filtration device.

9. A control unit of a system (202) for extracting a liquid (203) from a tank (105) of a motor vehicle, comprising means for implementing all of the steps of the method for maintaining a device (201) for filtering the liquid as claimed in claim 1.

10. A system (202) for extracting a liquid (203) from a tank (105) of a motor vehicle comprising a reversible pump (204) and a filtration device (201), said reversible pump including a first port (204a) connected to the tank by means of the filtration device and a suction pipe (205), and a second port (204b) connected to an injection device by means of a discharge pipe (206), said extraction system further comprising a return pipe connected to the discharge pipe by its first end and connected to the tank by its second end, and a control unit as claimed in claim 9.

11. The extraction system as claimed in claim 10, said extraction system being suitable for extracting liquid additive from a dedicated tank of a motor vehicle and injecting said liquid additive into an exhaust gas treatment system of said motor vehicle.

12. The extraction system as claimed in claim 10, further comprising a second filtration device situated between the first and second ends of the return pipe.

13. The extraction system as claimed in claim 10, in which the second end of the return pipe is situated in the tank at a given height suitable for avoiding the intake of particles settled at the bottom of the tank or particles suspended on the surface of the liquid contained in the tank.

14. The method as claimed in claim 2, in which, during step b), each application criterion linked to the state of the liquid in the tank corresponds to the meeting of at least one given condition of the following conditions:
the tank contains a quantity of liquid greater than a given threshold value;
the vehicle is stationary;
a value associated with a given quality criterion of the liquid is greater than a given threshold value; and
the time elapsed between two given driving cycles of the vehicle is greater than a given threshold value.

15. The method as claimed in claim 3, in which, during step b), each application criterion linked to the state of the liquid in the tank corresponds to the meeting of at least one given condition of the following conditions:
the tank contains a quantity of liquid greater than a given threshold value;
the vehicle is stationary;
a value associated with a given quality criterion of the liquid is greater than a given threshold value; and
the time elapsed between two given driving cycles of the vehicle is greater than a given threshold value.

16. The method as claimed in claim 2, in which, during step c), the generation of the reverse stream of liquid going from the tank to the tank, in the direction from the return pipe towards the suction pipe, is stopped when at least one of the following conditions is met:
the reverse stream is generated for a time greater than a given threshold value;
the pressure measured in the pressure pipe by a pressure sensor drops by a value greater than a given threshold value in a given time interval; and
the pressure measured in the pressure pipe by a pressure sensor drops is greater than a given threshold value for a given time.

17. The method as claimed in claim 3, in which, during step c), the generation of the reverse stream of liquid going from the tank to the tank, in the direction from the return pipe towards the suction pipe, is stopped when at least one of the following conditions is met:
the reverse stream is generated for a time greater than a given threshold value;
the pressure measured in the pressure pipe by a pressure sensor drops by a value greater than a given threshold value in a given time interval; and
the pressure measured in the pressure pipe by a pressure sensor drops is greater than a given threshold value for a given time.

18. The method as claimed in claim 4, in which, during step c), the generation of the reverse stream of liquid going from the tank to the tank, in the direction from the return pipe towards the suction pipe, is stopped when at least one of the following conditions is met:
the reverse stream is generated for a time greater than a given threshold value;
the pressure measured in the pressure pipe by a pressure sensor drops by a value greater than a given threshold value in a given time interval; and
the pressure measured in the pressure pipe by a pressure sensor drops is greater than a given threshold value for a given time.

19. The method as claimed in claim 5, in which, during step c), the generation of the reverse stream of liquid going from the tank to the tank, in the direction from the return pipe towards the suction pipe, is stopped when at least one of the following conditions is met:
the reverse stream is generated for a time greater than a given threshold value;
the pressure measured in the pressure pipe by a pressure sensor drops by a value greater than a given threshold value in a given time interval; and
the pressure measured in the pressure pipe by a pressure sensor drops is greater than a given threshold value for a given time.

20. The method as claimed in claim 2, further comprising, following the performance of step c), a second performance of step a) and, if the choking of the filtration device is detected, the storing in a memory of an item of information associated with the deterioration of the filtration device and/or the issuing of a warning, by means of a human-machine interface of the vehicle, indicating the deterioration of the filtration device.
